(19) United States
(12) Patent Application Publication
(10) Pub. No.: US 2018/0337556 A1
(43) Pub. Date: Nov. 22, 2018

(54) NON-CONTACT POWER TRANSMISSION STRUCTURE FOR SLIDING DOOR

(71) Applicants: HYUNDAI MOTOR COMPANY, Seoul (KR); KIA Motors Corporation, Seoul (KR)

(72) Inventors: Hyung In Yun, Incheon (KR); Myoung Kwon Je, Hwaseong-si (KR)

(73) Assignees: HYUNDAI MOTOR COMPANY, Seoul (KR); KIA Motors Corporation, Seoul (KR)

(21) Appl. No.: 15/835,367

(22) Filed: Dec. 7, 2017

(30) Foreign Application Priority Data
May 17, 2017 (KR) 10-2017-0060867

(51) Int. Cl. H02J 50/10; E05D 15/06

(52) U.S. Cl. CPC H02J 50/10; E05D 15/063; B60J 5/06; E05Y 2900/531; E05D 15/0656

(57) ABSTRACT

The present invention relates to a non-contact power transmission structure for a sliding door on a vehicle, the structure controlling opening/closing of the sliding door by generating electromagnetic induction energy. The non-contact power transmission structure for a sliding door includes: a rail disposed longitudinally on a side of a vehicle to guide a sliding door; a transmission coil disposed in the rail; and a roller assembly disposed on the sliding door to move along the rail, in which the roller assembly includes: a roller disposed on the sliding door so that the roller assembly moves along the rail; and a reception coil corresponding to at least a portion of the transmission coil, in which the reception coil generates electromagnetic induction electric energy to open and close the sliding door, using electric energy generated at the transmission coil.

### CROSS REFERENCE TO RELATED APPLICATION

The present application claims priority to and benefit of Korean Patent Application No. 10-2017-0060867, filed May 17, 2017, the entire contents of which is incorporated herein for all purposes by this reference.

### BACKGROUND

### Technical Field

The present disclosure relates to a non-contact power transmission structure for a sliding door and, more particularly, to a non-contact power transmission structure for a sliding door, the structure provided between a vehicle body and a sliding door in the vehicle to transmit power for opening/closing the sliding door using electromagnetic induction.

### Description of the Related Art

In general, large commercial vehicles such as buses and multi-purpose vehicles are equipped with a sliding door system so that passengers can easily get on and off the vehicles.

A conventional sliding door system typically includes a sliding door installed to move along a rail on a vehicle body to open/close a door opening formed on the vehicle body, a load operating as a power source for moving the sliding door, a micro switch for sensing closing of the sliding door, and a controller for controlling opening/closing of the sliding door by controlling the load on the basis of a sensing signal from the micro switch.

Further, the sliding door system functions to safely close the sliding door to prevent damage to objects or passengers when the objects or passengers are stuck in the space between the sliding door and the door opening while the sliding door closes the door opening.

However, conventional systems experienced problems where a power cable 20 of a connector 20 disposed between the sliding door and the vehicle body to receive power from the vehicle body was exposed when the sliding door was open. The exposed portion of power cable 20 may be damaged when passengers get on and off the vehicle with sliding door 10 open, and there is also a possibility that the passengers can be injured.

Further, the operation path of sliding door 10 (when the sliding door is opened and closed) and the operation path of power cable 20 when the sliding door is operated are different, so there is a possibility that power cable 20 shows an abnormal behavior when sliding door 10 is operated, resulting in damage to the vehicle body.

Accordingly, there is a need for a non-contact connecting structure for supplying power between a sliding door and a vehicle body.

### DOCUMENTS OF RELATED ART

(Patent Document 1) Korean Patent Application No. 10-2013-0021302

### SUMMARY OF THE DISCLOSURE

The present disclosure addresses the above problems by providing a non-contact structure for transmitting power between a sliding door and a vehicle body.
to the disclosure further provides a non-contact energy transmission structure using electromagnetic induction between coils on a rail and a coil at an end of a sliding door.
to the disclosure further provides a structure for coupling a sliding door and a vehicle body without exposing a power cable.

The disclosure is not limited to the example embodiments described above, and other objects of the present disclosure not stated herein may be easily understood from the following description and may be made clear by detailed descriptions of example embodiments. Further, the objects of the present disclosure can be achieved by the components described in claims and combinations thereof.

A non-contact power transmission structure for a sliding door for achieving the objects set forth above includes the following configurations.

IN an example embodiment, a non-contact power transmission structure for a sliding door comprises: a rail disposed longitudinally on a side of a vehicle to guide a sliding door; a transmission coil disposed in the rail; and a roller assembly disposed on the sliding door to move along the rail, in which the roller assembly comprises: a roller disposed on the sliding door so that the roller assembly moves along the rail; and a reception coil corresponding to at least a portion of the transmission coil, in which the reception coil generates electromagnetic induction electric energy to open and close the sliding door, using electric energy generated at the transmission coil.

In a further example embodiment, the structure may further include a coil cover for covering the transmission coil.

In a further example embodiment, the structure may further include: a power supply providing electric energy to the transmission coil; and a controller performing control to apply electric energy to the transmission coil in response to a request for opening the sliding door.

In a further example embodiment, the structure may further include a door controller controlling opening and closing of the sliding door, depending on the electromagnetic induction electric energy generated at the reception coil.

The electromagnetic induction electric energy generated by the reception coil may be transmitted to a load through a rectifier or a power converter disposed in the sliding door.

The transmission coil may be provided to correspond to a distance that the sliding door moves to open and close.

In a further example embodiment, the structure may further include a core disposed at a first end of the roller assembly to cover the reception coil.

In a further example embodiment, the structure may further include a lead wire extending from the reception coil and connected to the inside of the sliding door.

The rail is disposed on at least both top and bottom ends of the sliding door.

The reception coil may not be in contact with the transmission coil.

The power supply may be a battery disposed in the vehicle.

The controller may communicate with a receiving module in the sliding door through a transmitting module in the vehicle.

The electromagnetic induction electric energy may be provided to control opening and closing of the sliding door through a load disposed in the sliding door.

The embodiments described in the present disclosure and claimed can provide the following beneficial effects described below.

Using the non-contact power transmission structure for a sliding door described and claimed herein, it is possible to improve the aesthetic appearance of a vehicle by removing a cable structure that is exposed between a sliding door and a vehicle when the sliding door is opened.

Moreover, because removal of a cable structure that is exposed between a sliding door and a vehicle, reduces the possibility that passengers may be injured when getting on/off a vehicle.

Furthermore, because the operation path of a sliding door and the operation path of a power transmission system are the same, it is possible to prevent abnormal behavior of the power transmission system that may result in damage to the vehicle body.

### BRIEF DESCRIPTION OF THE DRAWINGS

The above and other objects, features and other advantages will be more clearly understood from the following detailed description when taken in conjunction with the accompanying drawings, in which:

FIG. 1 is a view showing a conventional power cable structure exposed with a sliding door open.

FIG. 2 is a block diagram showing a non-contact power transmission structure for a sliding door according to an embodiment.

FIG. 3 is a view showing a rail on a side of the floor of a vehicle according to an example embodiment.

FIG. 4 is a vertical cross-sectional view of the rail according to an example embodiment.

FIG. 5 is a perspective view of a roller assembly according to an example embodiment.

FIG. 6 is a view showing the roller assembly mounted on a rail according to an example embodiment.

FIG. 7 is a view showing the roller assembly coupled to the rail on a side of the floor of a vehicle according to an example embodiment.

### DETAILED DESCRIPTION

Hereinafter, example embodiments will be described in more detail with reference to the accompanying drawings. It should be understood that these embodiments may be modified in various ways and the scope of the present disclosure should not be construed as being limited to the following embodiments. The embodiments are provided to more completely explain the present invention to those skilled in the art.

Further, in the specification, the terms “˜unit” and “˜module” mean one unit for processing at least one function or operation and may be achieved by hardware, software, or a combination of hardware and software.

The terms “electric energy” and “power” stated herein are used as meanings that include all of energy produced by a current and a voltage that are applied to operate a load 140.

The present disclosure relates to a non-contact power transmission structure for a sliding door 100, that is, to a structure including at least one or more rails 210 disposed on a side of a vehicle 200 so that the sliding door 100 moves in the longitudinal direction of vehicle 200 along rails 210.

The present disclosure provides a non-contact power transmission structure for sliding door 100, wherein the structure transmits power without contact between vehicle 200 and sliding door 100 using electromagnetic induction between a transmission coil 211 disposed at rail 210 and a reception coil 111 disposed at a roller assembly 110 connected to sliding door 100.

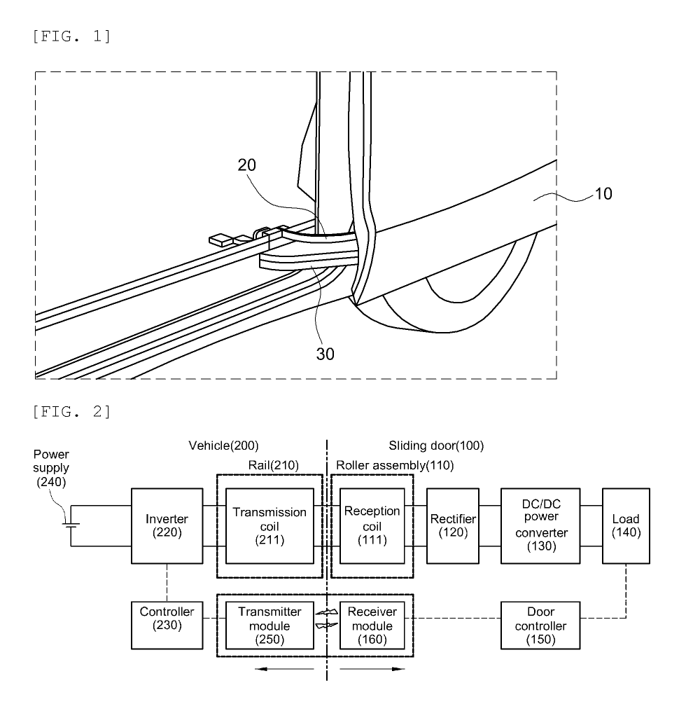

FIG. 1 is a view showing a conventional power cable structure exposed with a sliding door open.

A door system for opening/closing sliding door using a power supply 240 on vehicle 200 is shown and a power cable 20 for electrical connection to sliding door 100 is exposed between vehicle 200 and sliding door 100.

Power required by sliding door 100, for example, to operate a door glass while sliding door 100 is opened or closed is supplied through the power cable 20, which is exposed between vehicle 200 and sliding door 100 when sliding door 100 is open.

Exposed power cable 20 may be damaged by a passenger getting on/off the vehicle, and/or a passenger may be injured by tripping on the exposed power cable when getting on/off the vehicle.

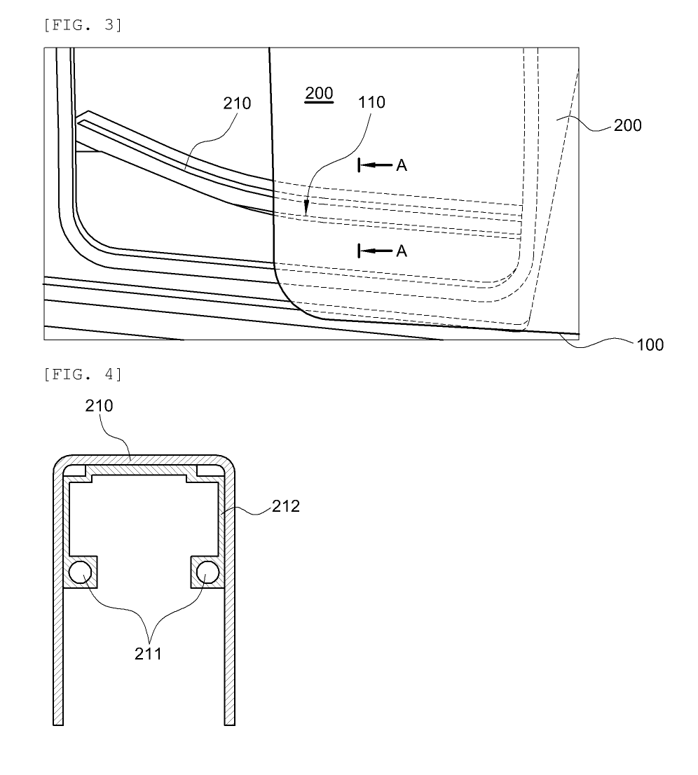

FIG. 2 is a schematic showing the configuration of a non-contact power transmission structure for sliding door 100 according to an example embodiment of the present disclosure.

As shown in FIG. 2, power supply 240 on vehicle 200 supplies electric energy to transmission coil 211 through an inverter 220 in response to a request for opening/closing sliding door 100 by a user. A controller 230 on vehicle 200 controls inverter 220 to set the frequency of the electric energy that is transmitted to reception coil 211 from power supply 240.

In this embodiment, the structure includes transmission coil 211 disposed in at least one rail 210 disposed on a side of vehicle 200 where sliding door 100 is also disposed, and DC power supplied from power supply 240 is converted into AC power through inverter 220 and then transmitted to transmission coil 211.

Sliding door 100 may be disposed on at least one side of the vehicle 200 or sliding doors 100 may be disposed on each side of vehicle 200.

A request to open/close sliding door 100 may be input through a button in the vehicle, handle levers on the inner and outer sides of sliding door 100, activation of a key fob, and/or screen-based controls in the vehicle, among other methods for opening/closing the doors of vehicle 200 known by those in the art.

In an example embodiment, the structure includes roller assembly 110 connecting sliding door 100 and vehicle 200 to each other. A first end of roller assembly 110 can move in the longitudinal direction of vehicle 200 on rail 210 disposed on vehicle 200. Accordingly, sliding door 100 can be opened and closed by roller assembly 110 moving along rail 210 disposed in the longitudinal direction of vehicle 200.

In an example embodiment, roller assembly 110 that moves along rail 210 includes at least one or more rollers 112 and a reception coil 111 corresponding to at least a portion of transmission coil 211. Transmission coil 211 and reception coil 111 are not in direct physical contact.

Transmission coil 211 and reception coil 111 generate electromagnetic induction in the area where they correspond to each other, that is, electromagnetic induction electric energy is generated at reception coil 111 by electric energy generated by transmission coil 211.

The electromagnetic induction electric energy generated at reception coil 111 is transmitted to a load 140 through a rectifier 120 and a power converter 130 disposed in sliding door 100. In a preferred embodiment, Rectifier 120 and power converter 130 are sequentially disposed between reception coil 111 and load 140.

Load 140 disposed in sliding door 100 may include a component for providing power for opening/closing sliding door 100, that is, may include all components needed to provide power such as an actuator or an electric motor.

Rectifier 120 converts the electromagnetic induction electric energy generated at reception coil 111 from AC into DC and power converter 130 can be controlled by a door controller 150 to transmit appropriate power to load 140 for opening sliding door 100.

Further, controller 230 in vehicle 200, which communicates with a receiver module 160 connected to door controller 150 through transmitter module 150, controls power from power supply 240 in response to a signal for opening/closing sliding door 100 received from vehicle 200, received from sliding door 100, received from a key fob, or received from any other source.

In an example embodiment, control instructions output from controller 230 to open/close the window of sliding door 100, open/close sliding door 100, and open/close a sunshade are transmitted to door controller 150 of sliding door 100 through transmitter module 250.

Receiver module 160 at sliding door 100 receives the control instructions transmitted through transmitter module 250 from controller 230 and door controller 150 performs the requested control operation on sliding door 100.

In an example embodiment, transmitter module 250 and receiver module 160 that perform near field communication can selectively use Zigbee, Bluetooth, WiFi, Binary CDMA, and other communication methods using wireless LAN, but the communication method between transmitter module 250 and receiver module 160 is not limited to these wireless communication methods.

FIG. 3 shows rail 210 disposed at the lower end of a side of vehicle in an example embodiment.

As shown in FIG. 3, vehicle 200 and sliding door 100 are connected by one or more connecting structures; For example, rails 210 at upper and lower portions of a side of vehicle 200. In this embodiment, sliding door 100 may be connected to vehicle 200 by having the roller assembly 110 in communication with rails 210.

FIG. 4 is a vertical cross-sectional view of rail 210 in an example embodiment.

Rail 210 is longitudinally disposed on a side of vehicle 200. As shown in FIG. 4, transmission coil 211 is positioned on the inner side of rail 210 along the length of rail 210. A coil cover 212 covers transmission coil 211 to protect transmission coil 211 from external shock and from separating from the inner side of rail 210.

In an example embodiment, transmission coil 211 extends longitudinally along rail 210 and winds along both ends of rail 210. Transmission coil cover 212 is disposed along transmission coil 211 in rail 210. Coil cover 212 may be configured such that transmission coil 211 is wound along the rail 210 and both longitudinal ends of coil cover 212 are open.

In another example embodiment, transmission coil 211 is configured to correspond to the distance that sliding door 100 moves to open/close. Electromagnetic induction current flows between transmission coil 211 and reception coil 111 even while the sliding door 100 is moving.

Electricity is transmitted to the one or more rails 210 on the side of vehicle 200 through sliding door 100 and roller assembly 110, as described above. When a current is applied to transmission coil 211 and power is generated, the current flows through transmission coil 211 and a current also flow through the reception coil 111 as a result of electromagnet induction, so electromagnetic induction electric energy is provided into sliding door 100.

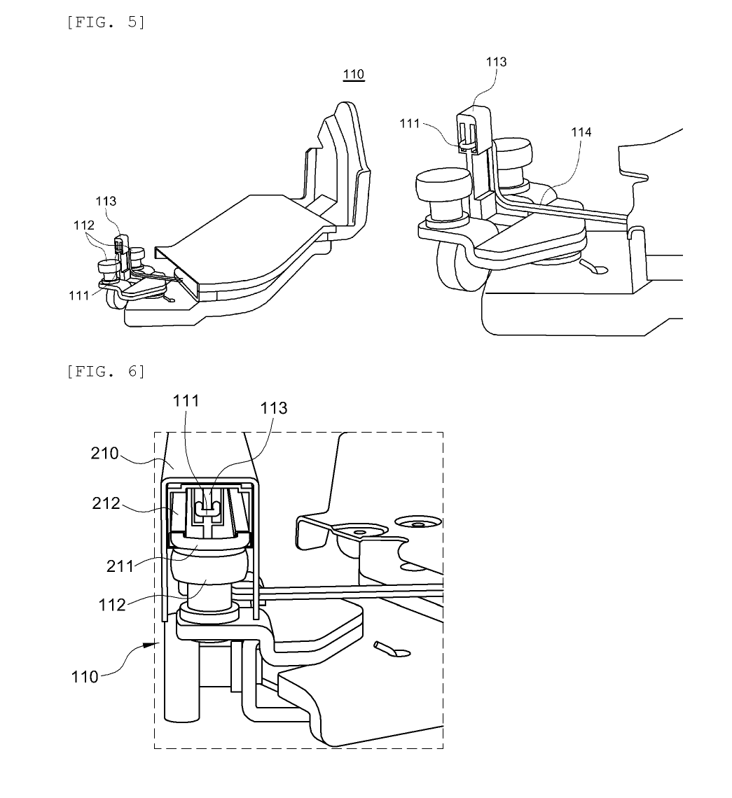

FIG. 5A is a view showing the configuration of roller assembly 110 for sliding door 100 according to an example embodiment.

FIG. 5B is an exploded view of 5A.

A first end of roller assembly 110 is connected to sliding door 100 and a second end is disposed in the rail 210 (see FIG. 6), so when roller assembly 110 moves along rail 210, sliding door 110 is moved in the longitudinal direction of vehicle 200.

The second end of the roller assembly 110 disposed in rail 210 has at least one or more rollers 112 facing the inner sides of rail 210 so that when sliding door 100 is moved to open/close in the longitudinal direction of e vehicle 200, roller assembly 110 can be moved along the inner sides of rail 210 (see FIG. 6).

In a further example embodiment, the structure includes a core 113 disposed at the second end of roller assembly 110 to be inserted in rail 210. Reception coil 111 is wound inside core 113 to correspond to transmission coil 211.

In addition, an end of reception coil 111 extends to form a lead wire 114, which is electrically connected with load 140 in sliding door 100.

Reception coil 111 may be wound inside core 113 to correspond to at least a portion of transmission coil 211 and reception coil 111 and transmission coil 211 are physically spaced at a predetermined distance from each other, thereby forming a non-contact configuration.

FIG. 6 shows a non-contact power transmission structure for sliding door 100 combined with rail 210 and the roller assembly 110 in an example embodiment.

FIG. 6 shows roller assembly 110 inserted in rail 210 on vehicle 200. Roller assembly 110 includes one or more rollers 112 so that roller assembly 110 can smoothly move in rail 210 in the longitudinal direction of vehicle 200, thereby causing sliding door 100 to move longitudinally along vehicle 200.

Core 113 is disposed at an end of roller assembly 110, which is inserted in rail 210, and contains reception coil 111 corresponding to at least a portion of reception coil 211. Reception coil 111 and transmission coil 211 are arranged in parallel so as not to be in contact with each other, so when electric energy is applied to transmission coil 211 from power supply 240 in e vehicle 200, electromagnetic induction electric energy is generated at reception coil 211.

The electromagnetic induction electric energy generated along reception coil 111 is transmitted into sliding door 100 through lead wire 114 extending from reception coil 111.

The electromagnetic induction electric energy generated at reception coil 111 is transmitted through lead wire 114 and converted from AC power into DC power by rectifier 120 disposed in sliding door 100.

The DC power is transmitted to load 140 through power converter 130 so that sliding door 100 can be opened/closed. Door controller 150 controls the AC power passing through rectifier 120 to be converted into available power for operating load 140 through e power converter 130 and controls the power and the operation time of load 140.

In a further example embodiment, load 140 may be a bidirectional electric motor in sliding door 100 and the operational direction of the electric motor can be controlled by controller 230, so the electric motor controls opening/closing of sliding door 100.

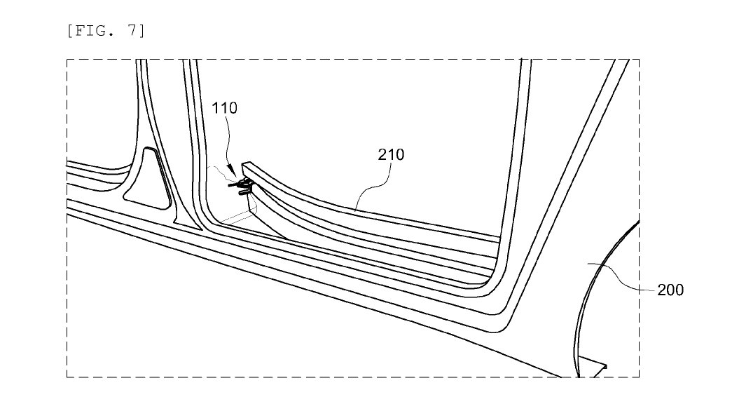

FIG. 7 is an assembly view of the non-contact power transmission structure for sliding door 100 according to an example embodiment.

At least one or more rails 210 are disposed on a side of vehicle 200 that faces sliding door 100 and FIG. 7 shows a bottom rail 210 and a roller assembly 110 combined with rail 210.

Rail 210 has a first end having a predetermined curvature inside vehicle 200 so that an opening in vehicle 200 is closed when sliding door 100 is closed.

In contrast, when sliding door 100 is pushed to open, controller 230 in vehicle 200 controls power supply 240 to transmit electric energy to transmission coil 211, thereby generating electromagnetic induction electric energy at reception coil 111 in sliding door 100.

Load 140 in sliding door 100 provides power for opening sliding door 100 by the electromagnetic induction electric energy generated at reception coil 111, an, in an example embodiment, this energy may be used to open sliding door 100, for example with an electric motor.

As described above, in an example embodiment, the structure includes transmission coil 211 and reception coil 111 that generate electromagnetic induction, so it is possible to achieve a non-contact power transmission structure for sliding door 100 without a cable fastened by a wire to roller assembly 110 and the inside of rail 210.

The example embodiments described above may be used in other various combinations, changes, and situations. That is, the present invention may be changed or modified within the range of the concept of the present invention, the range equivalent to the above description, and/or the range of the technologies and knowledge in the art. The embodiments may be changed in various ways for the detailed application and the use of the present invention. Accordingly, the above description does not limit the present invention to the embodiments. Further, the claims should be construed as including other embodiments.

What is claimed is:

1. A non-contact power transmission structure for a sliding door, the structure comprising:
a rail disposed longitudinally on a side of a vehicle to guide the sliding door;
a transmission coil disposed in the rail; and
a roller assembly disposed on the sliding door to move along the rail,
wherein the roller assembly includes:
a reception coil corresponding to at least a portion of the transmission coil.

2. The structure of claim 1, wherein the reception coil generates electromagnetic induction electric energy to open and close the sliding door, using electric energy generated at the transmission coil.

3. The structure of claim 1, wherein the roller assembly further comprises a roller disposed on the sliding door so that the roller assembly moves along the rail.

4. The structure of claim 1, further comprising a coil cover covering the transmission coil.

5. The structure of claim 1, further comprising:
a power supply providing electric energy to the transmission coil; and
a controller that controls the supply of electric energy to the transmission coil in response to a request for opening or closing the sliding door.

6. The structure of claim 1, further comprising a door controller controlling opening and closing of the sliding door, depending on the electromagnetic induction electric energy generated at the reception coil.

7. The structure of claim 1, wherein the electromagnetic induction electric energy generated by the reception coil is transmitted to a load through a rectifier or a power converter disposed in the sliding door.

8. The structure of claim 1, wherein the transmission coil is configured to have a length corresponding to a distance that the sliding door moves to open and close.

9. The structure of claim 1, further comprising a core disposed at a first end of the roller assembly to cover the reception coil.

10. The structure of claim 1, further comprising a lead wire extending from the reception coil and connected to the inside of the sliding door.

11. The structure of claim 1, wherein the rail is disposed on each of a top and bottom end of the sliding door.

12. The structure of claim 1, wherein the reception coil is not in direct physical contact with the transmission coil.

13. The structure of claim 5, wherein the power supply is a battery disposed in the vehicle.

14. The structure of claim 5, wherein the controller communicates with a receiver module disposed in the sliding door through a transmitter module disposed in the vehicle.

15. The structure of claim 1, wherein the electromagnetic induction electric energy is provided to control opening and closing of the sliding door through a load disposed in the sliding door.
